(19) United States
(12) Patent Application Publication
(10) Pub. No.: US 2024/0377193 A1
(43) Pub. Date: Nov. 14, 2024

(54) SYSTEM AND METHOD FOR MEASUREMENT OF FAN BLADE TIP CLEARANCE FOR A TURBINE ENGINE

(71) Applicant: GENERAL ELECTRIC COMPANY, Schenectady, NY (US)

(72) Inventors: Subramanya Shankar, Bangalore (IN); Kirti Arvind Petkar, Bangalore (IN); Nagamohan G P, Bangalore (IN); Ravindra Shankar Ganiger, Bangalore (IN)

(21) Appl. No.: 18/339,370

(22) Filed: Jun. 22, 2023

(30) Foreign Application Priority Data
May 10, 2023 (IN) 202311032976

(51) Int. Cl. G01B 21/16

(52) U.S. Cl. CPC G01B 21/16

(57) ABSTRACT

A gas turbine engine includes a fan assembly, a compressor section, a combustor section, and a turbine section in serial flow arrangement, and defining an engine centerline. Sets of fan blades within the fan assembly can be rotatably driven about the engine centerline within a casing wall. A fan blade tip clearance is defined as a gap between the set of fan blades and the fan casing assembly. A clearance measurement system including a pad with one or more integrated sensors provides for measuring the gap.

### TECHNICAL FIELD

The present disclosure relates generally to a system for measuring blade tip clearances, and more specifically to measuring fan blade tip clearances in a turbine engine.

### BACKGROUND

A turbine engine typically includes an engine core with a compressor section, a combustor section, and a turbine section in serial flow arrangement. A fan section can be provided upstream of the engine core having a fan casing and a set of fan blades, operably coupled to the engine core, and providing a flow of air to the engine core. The fan blades are spaced from the fan casing by a tip clearance gap. The tip clearance gap is traditionally measured by hand by a technician, by inserting one or more shims and gauges into the tip clearance gap to measure the spacing.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic cross-sectional view of a turbine engine including a fan casing assembly, in accordance with an exemplary aspect of the present disclosure.

FIG. 2 is a schematic perspective view of a fan blade and a disk suitable for use within the turbine engine of FIG. 1, in accordance with an exemplary aspect of the present disclosure.

FIG. 3 is a perspective view of a clearance measurement system positioned within a gap between the fan casing assembly of FIG. 1, and the fan blade of FIG. 2, in accordance with an exemplary aspect of the present disclosure.

FIG. 4 is a top view of the clearance measurement system of FIG. 3 connected to a CPU and a display, in accordance with an exemplary aspect of the present disclosure.

FIG. 5 is a perspective view of another clearance measurement system positioned within a gap between a fan casing assembly and a fan blade, provided as a strain sensor, in accordance with an exemplary aspect of the present disclosure.

FIG. 6 is a partial section view of the clearance measurement system of FIG. 5 showing a pressure force acting on the clearance measurement system, in accordance with an exemplary aspect of the present disclosure.

FIG. 7 is a partial section view of the clearance measurement system of FIG. 5, showing a shear force acting on the clearance measurement system, in accordance with an exemplary aspect of the present disclosure.

FIG. 8 shows a flow chart showing a method of measuring fan blade tip clearance, in accordance with an exemplary aspect of the present disclosure.

### DETAILED DESCRIPTION

Aspects of the disclosure herein are directed to a turbine engine, and more specifically, to a fan blade assembly for a turbine engine and a system and method for measuring fan blade tip clearance for the fan blade assembly. The system and method are described in relation to a gas turbine engine. It should be understood, however, that the disclosure applies to other engine components of the turbine engine. In addition, it will be appreciated that the present disclosure may be applied to any other suitable environment, such as non-aircraft implementations including terrestrial and non-terrestrial applications where measuring a tip clearance for a rotating element may be desirable.

Reference will now be made in detail to present aspects of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all examples described herein should be considered exemplary.

As used herein, the terms “first” and “second” may be used interchangeably to distinguish one component from another and are not intended to signify location or importance of the individual components.

The terms “forward” and “aft” refer to relative positions within a turbine engine or vehicle, and refer to the normal operational attitude of the turbine engine or vehicle. For example, with regard to a turbine engine, forward refers to a position closer to an engine inlet and aft refers to a position closer to an engine nozzle or exhaust.

Additionally, as used herein, the terms “radial” or “radially” refer to a direction away from a common center. For example, in the overall context of a turbine engine, radial refers to a direction along a ray extending between a center longitudinal axis of the engine and an outer engine circumference.

All directional references (e.g., radial, axial, top, bottom, above, below, vertical, horizontal, clockface, forward, aft, etc.) as may be used herein are only used for identification purposes to aid the reader's understanding of the present disclosure, and do not create limitations, particularly as to the position, orientation, or use of aspects of the disclosure described herein. Connection references (e.g., coupled. connected, or variations thereof) are to be construed broadly and can include intermediate structural elements between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

The singular forms “a”, “an”, and “the” include plural references unless the context clearly dictates otherwise. Furthermore, as used herein, the term “set” or a “set” of elements can be any number of elements, including only one.

As used herein, a “controller” or “CPU” can include at least one processor and memory, while not every component needs at least one processor and memory. A controller or other similar component can include any known processor, microcontroller, or logic device, including, but not limited to: field programmable gate arrays (FPGA), an application specific integrated circuit (ASIC), a full authority digital engine control (FADEC), a proportional controller (P), a proportional integral controller (PI), a proportional derivative controller (PD), a proportional integral derivative controller (PID controller), a hardware-accelerated logic controller (e.g. for encoding, decoding, transcoding, etc.), the like, or a combination thereof. Non- limiting examples of a controller or CPU can be configured or adapted to run, operate, or otherwise execute program code, like software, to effect operational or functional outcomes, including carrying out various methods, functionality, processing tasks, calculations, comparisons, sensing or measuring of values, or the like, to enable or achieve the technical operations or operations described herein.

The operation or functional outcomes can be based on one or more inputs, stored data values, sensed or measured values, true or false indications, or the like. While “program code” or “software” is described, non-limiting examples of operable or executable instruction sets can include routines, programs, objects, components, data structures, algorithms, etc., that have the technical effect of performing particular tasks or implement particular abstract data types. In another non-limiting example, a controller or CPU can also include a data storage component accessible by the processor, including memory, such as transient, volatile, or non-transient, or non- volatile memory in non-limiting examples. Additional non-limiting examples of the memory can include Random Access Memory (RAM), Read-Only Memory (ROM), flash memory, or one or more different types of portable electronic memory, such as discs, DVDs, CD-ROMs, etc., or any suitable combination of these types of memory. The processor or CPU can be configured to run any suitable programs or executable instructions designed to carry out various methods, functionality, processing tasks, calculations, or the like, to enable or achieve the technical operations or operations described herein. The program can include a computer program product that can include machine-readable media for carrying or having machine-executable instructions or data structures stored thereon. Such machine-readable media can be any available media, which can be accessed by a general purpose or special purpose computer or other machine with a processor. Generally, such a computer program can include routines, programs, objects, components, data structures, algorithms, etc., that have the technical effect of performing particular tasks or implement particular abstract data types.

Additionally, as used herein, elements being “electrically coupled” or “communicatively coupled” can include an electric transmission or signal being sent, received, or communicated to or from such connected or coupled elements. Furthermore, such electrical connections or couplings can include a wired or wireless connection, or a combination thereof.

The disclosure can be implemented in any network or electrical control, operation, or communication system, any aircraft avionics system or network, or other aircraft electrical system. A non-limiting example of an electrical circuit environment that can include aspects of the disclosure can include an aircraft power system architecture, which enables production or supplying of electrical power from a power source (e.g., a generator or power storage unit or device), and delivers the electrical power to a set of electrical loads. Additional non-limiting elements can be included in such an architecture, such as sensors, transmitters, or transceivers in non-limiting examples.

The inventors' practice has proceeded in the foregoing manner of designing a system and method for simplifying measurement for blade tip clearances for fan blades for a turbine engine, while increasing accuracy and consistency of measurement, as well as measurement specific to the type of fan, fan blade or turbine engine.

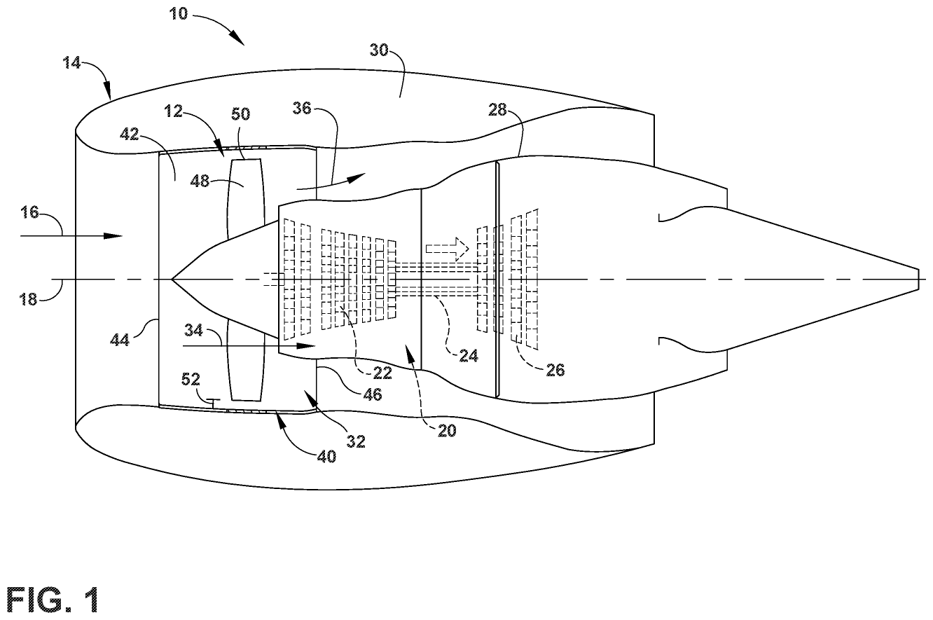

FIG. 1 illustrates an exemplary turbine engine 10 having a fan assembly 12, and a nacelle 14. The turbine engine 10 further includes an engine core 20 having a compressor section 22, a combustion section 24, and a turbine section 26 rotatable about an engine centerline 18. An inner cowl 28 radially surrounds the engine core 20 relative to the engine centerline 18.

Portions of the nacelle 14 have been cut away for clarity, while it should be appreciated that the nacelle 14 can be annular, provided about the engine core 20 and the fan assembly 12. The nacelle 14 surrounds the engine core 20 and the inner cowl 28. In this manner, the nacelle 14 forms an outer cowl 30 surrounding the inner cowl 28. The outer cowl 30 is spaced from the inner cowl 28 to form an annular passage 32 therebetween. The annular passage 32 can be a bypass duct, for example, permitting a portion of an airflow 16 to bypass the engine core 20.

The fan assembly 12 further includes an annular fan casing assembly 40 having an annular casing wall 42 extending between a forward end 44 and an aft end 46. The casing wall 42 can be formed into or as part of the nacelle 14 or outer cowl 30, or can be coupled thereto, curving in the annular direction. The fan assembly 12 further includes fan blades 48 rotatable to provide a volume of air to the annular passage 32 and the engine core 20. Each fan blade 48 includes a radial end 50. The radial end 50 is spaced from the casing wall 42 by a gap 52 permitting rotation of the fan blades 48 without contact with the casing wall 42.

In operation, the airflow 16 flows through the fan assembly 12 and separates into a first portion 34 and a second portion 36. The first portion 34 is channeled through the engine core 20 to the compressor section 22 wherein the airflow is further compressed and delivered to the combustion section 24. Hot products of combustion (not shown) from the combustion section 24 are utilized to drive turbine(s) in the turbine section 26 and thus produce engine thrust. The annular passage 32 is utilized to bypass the second portion 36 around engine core 20.

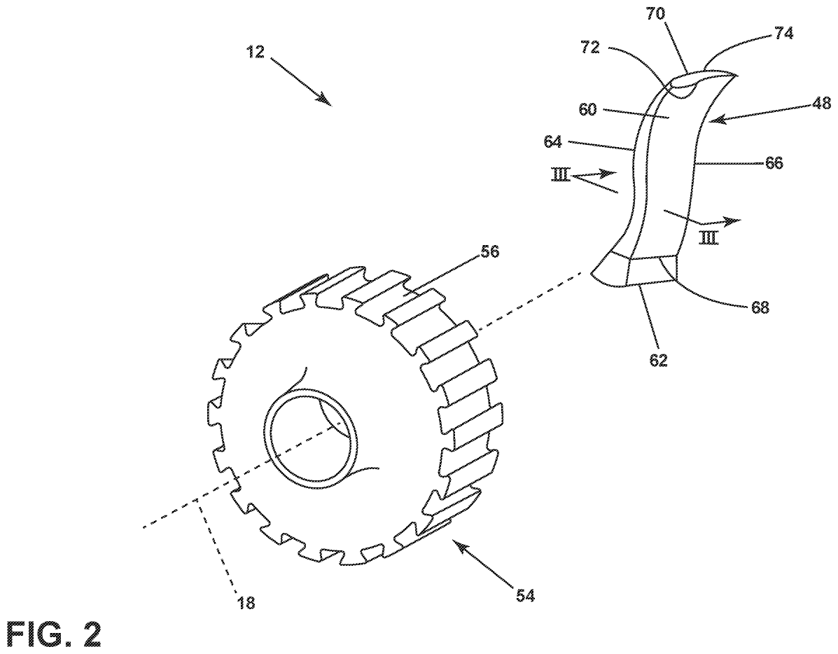

FIG. 2 is an exploded, schematic view of portions of the fan assembly 12 of FIG. 1, showing one fan blade 48 exploded from a disk 54. The disk 54 is rotatable about the engine centerline 18, for example, and includes a plurality of slots 56 extending axially through and circumferentially spaced about the radial exterior of the disk 54.

The fan blade 48 further includes an airfoil portion 60 and a dovetail portion 62. The airfoil portion 60 extends between a leading edge 64 and a trailing edge 66 to define a chord-wise direction, between a blade root 68 and a blade tip 70 to define a span-wise direction, and includes a pressure side 72 and a suction side 74. The fan blade 48 couples to the disk 54 by inserting at least a portion of the dovetail portion 62 into a respective slot 56 of the plurality of slots 56. While only a single fan blade 48 is illustrated, it will be appreciated that there are a set of fan blades formed by multiple fan blades 48 utilized in the fan assembly 12.

During manufacture, assembly, maintenance, and inspection, each fan blade 48 may be subject to testing or measurement, including clearance measurement to ensure that the fan blades 48 are maintained within proper clearances. If clearances are not within proper limits, or where clearances among multiple or nearby fan blades, or subsets thereof are near a threshold, but not necessarily exceeding the threshold for each fan blade 48, the fan blades 48 can rub against the casing wall 42 at greater or harder rub forces than those anticipated within the thresholds.

Traditional fan blade tip clearance measurement is accomplished by individual measurement of each blade relative to a common surface, such as the fan casing. The fan blade tip clearance is measured with shims and a taper gauge inserted into a gap between the blades and the fan casing, and is measured by hand by a user. This strategy is time consuming and leads to different measured values resultant of technician-to-technician differences or blade-to-blade differences, such as position of measurement, position of the fan blade at measurement, or the angle at which shims and gauges are inserted into the gap to make a measurement in non-limiting examples. Such differences can lead to measurement errors, such as parallax error (angle of shim/gauge relative to blade), technician-to-technician measurement variation, blade- to-blade measurement variation, differences in measurement position determined by user, suction side versus pressure side measurements, gauge wear, gauge/shim stack error, or differences in stack measurement. Further, a user often stands or sits on the fan casing during measurement, which can further affect the accuracy of the measurements. Further yet, measuring the pressure side must be done from the aft direction, behind the fan blades, which is difficult for a technician to reach and permits measurement of the suction side only.

Fan blade tip clearance is important for maintaining efficient engine operation. If a clearance value is too small, there is a chance that the fan blade may rub the casing. Alternatively, if the clearance is too large, operational performance or efficiency of the engine is negatively impacted, and can lead to a stall of the fan. Additionally, if multiple blades are within thresholds, yet a grouping, set, or region of blades has a relatively larger or smaller clearance, relative to the other blades in the fan blade assembly, those blades can lead to balance issues with the rotating fan blades. Therefore, it is beneficial to ensure accurate and consistent measurement of the fan blade tip clearance among the full set of fan blades.

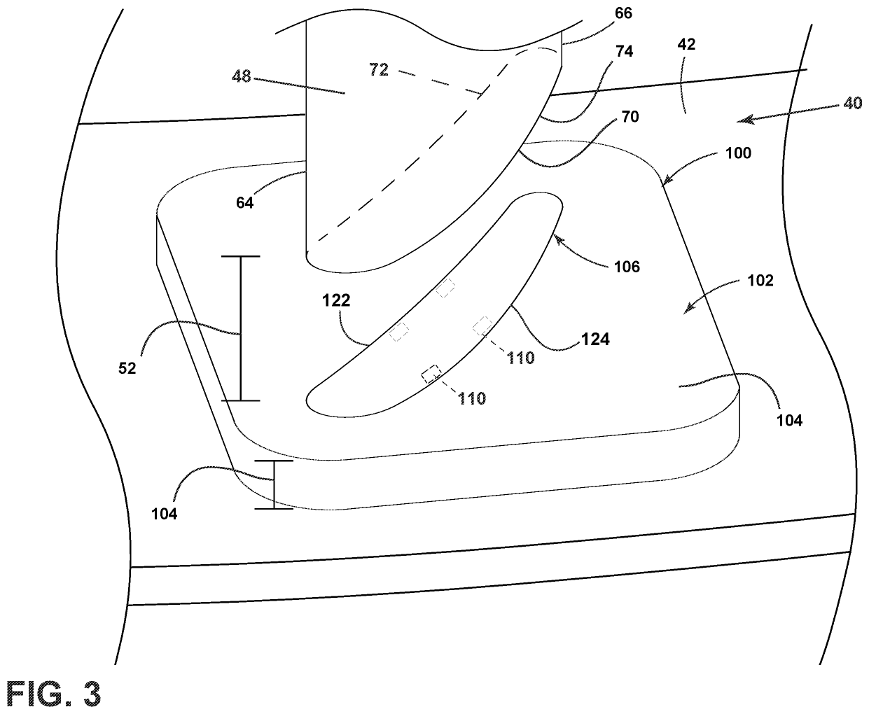

Referring to FIG. 3, a clearance measurement system 100 is used to measure the clearances in the gap 52 (FIG. 1). The clearance measurement system 100 includes a pad 102 having a thickness 104. The pad 102 can be made of a rubber material, or any other suitable flexible material. In one example, the rubber material can be a movable mat, similar to that of a mouse pad, permitting deformation of the pad 102 for positioning within the curved casing wall 42, as well as laid flat against the casing wall 42. The pad 102 can include markings 106, shown as an airfoil shape, which can be used to align the fan blade 48 relative to the pad 102. While the markings 106 are shown as an airfoil shape, it should be understood that any suitable markings for aligning a blade relative to the pad 102, or the pad 102 relative to the fan casing assembly 40 is contemplated. In one further non-limiting example, the clearance measurement system 100 can include a stop (not shown), such as a physical bumper, which can physically contact the fan blade 48 in order to align the fan blade 48 relative to the pad 102. Such a stop can be movable, to selectively permit movement or stopping of the fan blade 48 relative to the pad 102.

A sensor 110 is provided into, onto, or within the pad 102. The sensor 110 is shown as a set of sensors or multiple sensors, including four sensors 110, with a set of two sensors 110 provided on each of a pressure side 122 and a suction side 124 of the marking 106, which can correspond to the pressure side 72 and the suction side 74 of the fan blade 48 at the blade tip 70. In another non-limiting examples, the sensors 110 can be arranged at different positions on the pad 102, which can correspond to different chord-wise positions for each fan blade 48. While four sensors 110 are shown, any number of sensors 110 is contemplated in any suitable position or positions, such one sensor, as at least two sensors, or a set of sensors. In non-limiting examples, the sensors 110 can be positioned to measure the gap 52 at the rake angle, the tip angle, the pressure side 72, the suction side 74, the leading edge 64, the trailing edge 66, or any combination thereof. In one non-limiting example, the sensors 110 can be capacitor plates that are used to measure proximity of the fan blade 48, thereby measuring clearance. The sensors 110 can include a proximity sensor, a capacitance sensor, a resistance sensor, a distance sensor, a laser sensor, an ultrasonic sensor, an infrared sensor, an LED sensor, LIDAR, or VCSEL sensors in non-limiting examples.

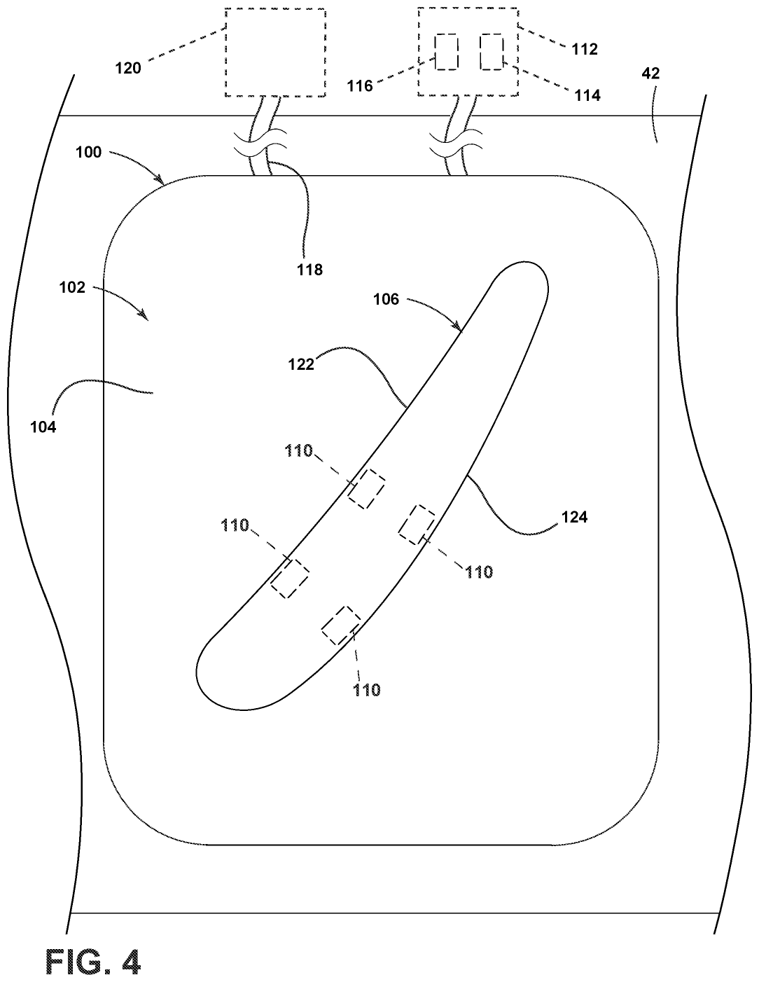

Referring to FIG. 4, the sensors 110 can be electrically and communicatively coupled to a controller, shown as a CPU 112 having a processor 114 and a memory 116. The sensors 110 are shown coupled to the CPU 112 and a display 120 by a wired connection 118, while a wireless or non-wired implementation is contemplated. In one example, the wired connection 118 can be used to supply electrical power to the sensors 110, and/or communicate measurements from the sensors 110 to the CPU 112. In another non-limiting alternative example, the pad 102 can include battery power and wireless communication, such that a wired connection is not required. In still another non-limiting example, the pad 102 can be configured to provide power to the display 120 via the pad 102, from the CPU 112 or other separate power source. The sensors 110 can be proximity sensors, generating a signal representative or indicative of a proximity of the fan blade 48 to the sensors 110. The CPU 112 can receive the signal, and can process or store measured values for the fan blade tip clearances based on the signal, or can access other relevant information, such as that related to the fan blade 48 or the particular engine, such as tip clearance threshold values for the turbine engine 10 (FIG. 1). The signal can be indicative of the distance between the pad 102 and the blade tip 70 (FIG. 3) as the tip clearance. The CPU 112 can account for the thickness 104 (FIG. 3) of the pad 102 in determining the tip clearances. In non-limiting examples, the display 120 can be a mobile computing device, laptop, smart phone, or the like, for outputting or displaying information related to the measurements made by the sensors 110.

Functionalities, or a set thereof, can include independent program code executions, functional modules, executions carried on functional modules, independent control modules or functions thereof, executable program partitions, or physical functions carried out by program or software execution, in non-limiting examples. Further components can include devices, such as a network switch or interface device. Additional components can include internet routers or transmitters, or other connectivity elements.

Furthermore, the information determined by the clearance measurement system 100 can be communicated to an aircraft carrying or powered by the turbine engine 10 (FIG. 1), or operational characteristics thereof, including systems, subsystems, contained systems, sensing, monitoring, or the like. Operation of the aircraft, and therefore the turbine engine 10, can include management, maintenance, inspection, or other oversight of components of the aircraft or turbine engine 10, and the components can be managed, controller, routed, or otherwise utilized to measure or otherwise report the clearance measurements. The CPU 112 can be pre-loaded with the aircraft architecture, turbine engine 10 architecture, or architecture information specific to the fan assembly 12 (FIG. 2) or fan blade 48 (FIG. 3), such as fan blade tip clearance thresholds, and can further be pre-loaded to include a set of functionalities related to the clearance measurement system 100. The particular architecture can include information specific to the fan blade 48, such as different fan blade tip clearance thresholds based on position of the blade (i.e., at trailing edge, leading edge, pressure side, suctions), blade count, engine type, average fan blade tip clearance thresholds, average fan blade tip clearance thresholds for a subset of fan blades, or other suitable architecture information relevant to the clearance measurement. Specific details or other information related to the functionalities can be included within or defined by the architecture as well, and are within the scope of this disclosure.

The aircraft architecture can further include information pertaining to a communication network. More specifically, information related to the communication network or the components thereon can include default values, threshold values, number of components, type of components, or any other historical information which may be relevant to a monitoring analysis of the network component. In this way, a network can provide for storing or otherwise utilizing historical information for fan blade tip clearances, which can be specific to an engine, blade type, or fleet, in non- limiting examples. There are trends that can be identified with the clearance measurements over time, such as seeing an increase or decrease in fan blade tip clearance due to normal wear from use, and such information can be identified by analysis of stored information.

In operation, the pad 102 can be positioned on the casing wall 42, such as removably resting on the casing wall 42. The markings 106 can include a shape complementary to the fan blades 48 (FIG. 2), and can be used to properly align the fan blade 48 relative to the pad 102, and therefore, the pad 102 relative to the casing wall 42. In one example, it is contemplated that the pad 102 or casing wall 42 can include additional markings permitting alignment of the pad 102 relative to the casing wall 42 prior to alignment of the fan blade 48 relative to the pad 102. Each fan blade 48 can be rotated such that the fan blade tip clearance for each fan blade 48 for any particular disk 54 (FIG. 2) is measured by the sensors 110. The particular position of the sensors 110 can be arranged relative to the markings 106 where the gap 52 (FIG. 3) is intended to be measured relative to the fan blade 48. Such positioning can be specific to the turbine engine 10 or the fan blade 48, for example. In another example, it is contemplated that the pad 102 include a plurality of sensors, positioned to measure different multiple different blades with one clearance measurement system 100. In such an example, multiple sensors can be used to position relative to different blade types, thereby providing the capability to make measurements specific to the blade implementation.

One or more gap measurements are made for each fan blade 48 (FIG. 2). The measurements or results can be displayed on the display 120, where a user can make a determination if the fan blade 48 is within clearance thresholds, such as a first threshold specific to each fan blade 48. In another example, the measurements can be provided to program code or software operating on the CPU 112, where the software can make determinations whether one or more fan blade tip clearances are within or outside of predetermined thresholds, and where such determinations can be output to the display 120. Furthermore, the clearance measurement system 100 can provide for determining fan blade tip clearances for a full set of fan blades 48, or a subset thereof, where an average fan blade tip clearance for the fan blades 48 can be compared to a second threshold. The second threshold can indicate where a balance or imbalance for the fan blades 48 can be determined among the fan assembly 12, even while each fan blade 48 can be within proper fan blade tip clearances such as the first threshold. While an average can be utilized to compare the fan blades 48 against the second threshold, alternative representations of the fan blade tip clearances among such as subset can include an average, mean, or median in non-limiting examples. In another non-limiting example, the first threshold, relating to each fan blade 48, can be different than the second threshold, relating to a set or subset of fan blades 48.

Measurements for the fan assembly 12 (FIG. 1), using the clearance measurement system 100, can be performed at manufacture of the turbine engine 10 (FIG. 1), for example. Additionally, the clearance measurement system 100 can be utilized for routine maintenance or inspection for aircraft quickly and consistently. For example, during pre-flight or post-flight inspection, the pad 102 can be easily placed on a casing wall 42 to determine if the fan blade 48 is still within fan blade tip clearances after previous flight or engine operation.

The clearance measurement system 100 described herein provides various benefits for measuring fan blade tip clearances, such as consistent, accurate, and quicker measurement of the fan blade tip clearance of the fan blades 48. Utilizing the pad 102 with the sensors 110 eliminates the opportunity for common measurement errors, such as those errors resultant from differences in technician-to-technician measurement, such as parallax error, measurement position, gauge wear, or the technician standing on the fan casing. Such accurate and consistent measurement provides for a reduction in maintenance costs and time, a reduction in fan blade tip clearance related blade rub or liberation, as well as a reduction in related operational disruptions resultant of fan blade rub or liberation.

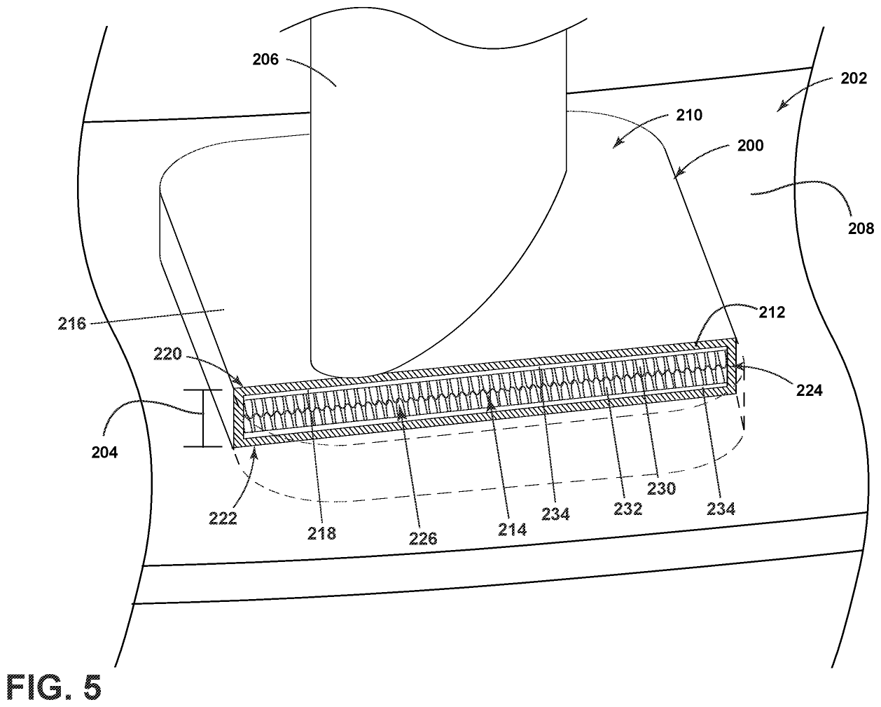

Referring now to FIG. 5, illustrated is a clearance measurement system 200 positioned on a fan casing assembly 202, similar to the fan casing assembly 40 of FIGS. 3-4, within a gap 204 between a fan blade 206 and a casing wall 208. The clearance measurement system 200 includes a pad 210. The pad 210 can be flexible or deformable, being capable of deformation in response to contact from the fan blade 206. A portion of the pad 210 is removed, as shown in broken line, to better illustrate the interior of the pad 210.

The pad 210 includes a housing 212 defining an interior 214. The housing 212 can include an exterior surface 216 and an interior surface 218. The housing 212 can further include a top 220 spaced from a bottom 222 by a sidewall 224. In one non- limiting example, the housing 212 can be formed of Polydimethylsiloxane (PMDS), while other suitable flexible materials are contemplated.

A sensor 226 is provided within the pad 210 as a first array of fibers 230 and a second array of fibers 232 are provided within the interior 214. Each of the first array of fibers 230 and the second array of fibers 232 can include a base layer 234, which can electrically and communicatively couple the first and second arrays of fibers 230, 232 to a CPU or display like the CPU 112 and display 120 of FIG. 4. The base layer 234 for the first array of fibers 230 can mount to the interior surface 218 at the top 220 and the base layer 234 for the second array of fibers 232 can mount to the interior surface 218 at the bottom 222. The first array of fibers 230 and the second array of fibers 232 can extend perpendicular to their respective base layer 234, for example. Furthermore, the first array of fibers 230 can overlap with, interlace with, or interlock with the second array of fibers 232, where at least a portion of the first array of fibers 230 is in contact with at least a portion of the second array of fibers 232.

An electrical current can be provided to the pad 210 and sensor 226, which can be conductive to permit the electrical current to conduct along the first and second arrays of fibers 230, 232. In one non-limiting example, the sensor 226 can be a resistive sensor that converts displacement, or other mechanical change, into an electrical signal which can be used to determine the gap 204. In one example, the sensors 226 can be arranged as a set of thin fibers, such as nano-hairs, where the sensor 226 determines the electrical resistance across the set of thin fibers to determine the gap 204. Additional non-limiting example resistive sensors can include thermistors, photoresistors, or potentiometers. Such a mechanical change can include a change in cross-sectional area or thickness, local length, temperature, or conductivity, as the length of the conductor is directly proportional to the resistance, and inversely proportional to the area of the conductor. In one example, resistance can be measured by a first expression:

$$R = \frac{pl}{A} \qquad ( 1 )$$

Where R represents the resistance for the sensor 226, p is the resistivity of the conductor, l is the length of the conductor, and A is the area of the conductor.

The pad 210 can be configured to generate a signal from the electrical current representative of the electrical resistance across the first and second arrays of fibers 230, 232 resultant from the mechanical change or other physical interaction among the first and second arrays of fibers 230, 232, resultant of the fan blade 206 contacting the pad 210, or lack thereof. As the fan blade 206 contacts the pad 210, the amount of contact between the first array of fibers 230 and the second array of fibers 232 changes, resulting in a greater area A across the conductor. As the area A is inversely proportional to the resistance R, the electrical resistance across the sensor 226 decreases as the area A increases.

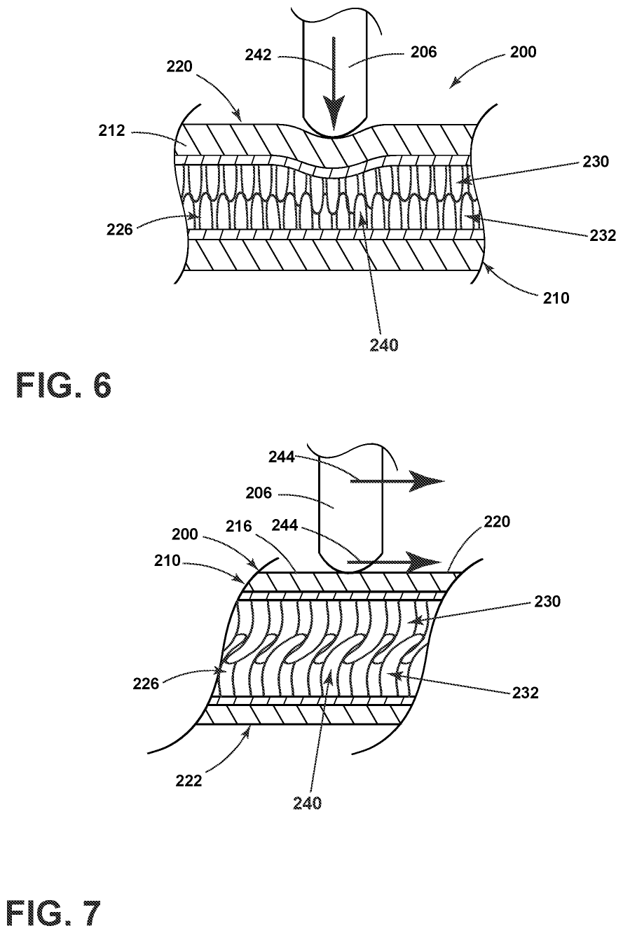

Referring to FIG. 6, a cross section of a portion of the clearance measurement system 200 and sensor 226, shown with a pressure force 242 acting on the housing 212 at the top 220, defining a mechanical change. The pressure force 242 can be generated by contact from the fan blade 206 (FIG. 5) pushing into the housing 212.

As can be appreciated, some of the first array of fibers 230 are pushed further into second array of fibers 232, resultant of the pressure force 242. Such pushed movement varies the amount of contact among the first array of fibers 230 and the second array of fibers 232, which varies the electrical resistance across the sensor 226. More specifically, resultant of the fan blade 206 contacting the housing 212, a greater area of the first array of fibers 230 contacts a greater area of the second array of fibers 232, thereby increasing the area across the sensor 226. This increased area decreases the electrical resistance, which can be represented by a signal output from the sensor 226. As the electrical resistance increases or decreases due to a change in contact between the first array of fibers 230 and the second array of fibers 232, and the output signal representative of the electrical resistance increases or decreases respectively. This output signal can be converted to represent a distance for the gap 204 (FIG. 5) based upon the measured electrical resistance, or change thereof. Furthermore, it should be understood that the clearance measurement system 200 can be calibrated to the output signal representing electrical resistance as a distance value for the gap 204.

Referring to FIG. 7, another cross section of a portion of the clearance measurement system 200 and the sensor 226 shows a strain or a shear force 244 acting across the top 220. In this way, the sensor 226 can be a strain sensor, determining a degree of strain along the first and second arrays of fibers 230, 232. The shear force 244 can be in a direction parallel to the exterior surface 216, while a variation from parallel is contemplated. The shear force 244 pushes the top 220 in a combination of a downward and a sideways direction away from a fixed position for the bottom 222. As a result, the first and second arrays of fibers 230, 232 can bend, changing the amount of contact among the first array of fibers 230 and the second array of fibers 232. Such a change in contact varies the area of contact among the first array of fibers 230 and the second array of fibers 232, which inversely varies electrical resistance along the clearance measurement system 200, similar to that described in reference to FIG. 6. For example, the shear force 244 can increase the amount of area in contact among the first array of fibers 230 and the second array of fibers 232, decreasing the electrical resistance across the sensor 226. Additional non-limiting examples of forces measurable with the first and second arrays of fibers 230, 232 include a pressure force, a shear force, an inertia, a centripetal force, a torsional force, or a compression force.

It should be appreciated that the interaction among the first array of fibers 230 and the second array of fibers 232 for the sensor 226, and the resultant signal output representative of the electrical resistance, can provide an indication for distance of the gap 204 (FIG. 5), as well as the structure of the fan blade 206 (FIG. 5) that varies the gap 204 during measurement. More specifically, the electrical resistance, and the output signal representative thereof, can indicate or be interpreted to indicate a directionality of the force acting upon the pad 210, such as a torsional directionality, a linear directionality, a shear directionality, or a curved directionality in non-limiting examples. More specifically, the electrical resistance varies based upon the area for the conductor. The directionality of the contact between the fan blade 206 and the pad 210 results in different areas of contact among the first array of fibers 230 and the second array of fibers 232, thereby resulting in different measured resistances. The clearance measurement system 200 can utilize this difference in measured electrical resistance to determine a directionality of the fan blade 206 or the type of force interacting with the pad 210. Utilizing a directionality or type of force can give greater detail regarding the shape of the fan blade 206 defining the gap 204. For example, the first and second arrays of fibers 230, 232 can output a signal representative of the electrical resistance, as well as indications of shear force, pressure force, torsional force, linear force, curved or angular force, or other force having a directionality defined in two or more dimensions. As the direction of the force varies in three dimensions, the interaction among the first and second arrays of fibers 230. 232 varies the electrical resistance, and therefore the output signal representative thereof. Such information can indicate whether the gap 204 is within a threshold distance, and can give specific information about the geometry of the fan blade 206 being within or outside of that threshold distance.

The clearance measurement system 200 can provide detailed clearance information, such as which portions or areas of the fan blade 206 (FIG. 5) are within or outside of thresholds. For example, the clearance measurement system 200 can indicate which areas or portions of the fan blade 206 are within thresholds, and which portions are outside of thresholds. Therefore, the need to position sensors relative to corresponding positions on the fan blade 206 is eliminated. That is, the clearance measurement system 200 can give representation of the gap 204 for the entire tip. Furthermore, detailed information about the set of blades, of which the fan blade 206 is one, or a subset thereof, can be measured. For example, if a subset of fan blades are within a threshold individually, but collectively are outside of a threshold defined for a particular area of the fan blade 206, the clearance measurement system 200 can indicate that via the output signal. More specifically, for example, if a subset of fan blades includes a pressure side that collectively is outside of a subset threshold, the clearance measurement system 200 can make such a determination and output that determination via the output signal, regardless of whether individual fan blades are within or outside of individual blade thresholds.

Furthermore, the capability to determine shear forces, or any other type of directional force, and account for them, permits a user to continually rotate a full set of the fan blades 206, without needing to stop and align individual fan blades for each individual measurement. This saves time during measurement, and can reduce required maintenance and inspection time investment.

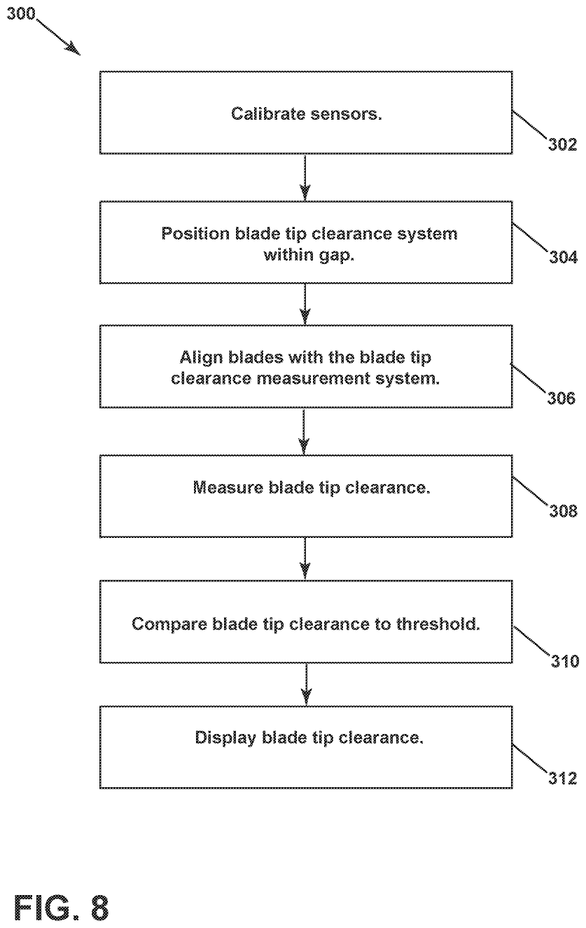

Referring to FIG. 8, a method 300 of measuring fan blade tip clearance between a fan casing, such as the fan casing assembly 40, 202 (FIGS. 1, 5), and a set of rotating blades, such as the fan blades 48, 206 (FIGS. 1, 5). The method 300 as shown in FIG. 8 need not be limited to the elements as shown, and can include more or less elements, and need not be in the order as provided unless specifically indicated.

At 302, the method 300 can include calibrating sensors, such as the sensors 110 (FIG. 3) or the clearance measurement system 200 (FIG. 5). Calibration can include tailoring or otherwise preparing the sensors 110 or the clearance measurement system 200 to measure the fan blade tip clearance for the particular engine, fan assembly, or blade. For example, information such as blade number, size, threshold fan blade tip clearance, sensor position or number, or type, can be provided, such that the sensors 110 or the clearance measurement system 200 is ready to make clearance measurements for the turbine engine 10, the fan assembly 12, or the fan blade 48. In one example, this information can be stored as data on the CPU 112 (FIG. 4), which can be accessed by the user through the use of software and the display 120, for example.

At 304, the method 300 can include positioning a clearance measurement system within a gap, such as the clearance measurement system 100, 200 (FIGS. 3, 5) and the gap 52, 204 (FIGS. 3, 5). The clearance measurement system 100, 200 positions within the gap 52, 204, and positions on the fan casing assembly 40, 202 or the casing wall 42, 208 (FIGS. 3, 5). In one example, the clearance measurement system 100, 200 includes a flexible pad, such as pad 102, 210 (FIGS. 3-4 and 7) that can be removably rest on or flex to conform to the shape of the casing wall 42, 208.

At 306, the method 300 can include aligning the fan blade 48, 206 of the set of fan blades 48, 206 (FIGS. 3, 5) with the clearance measurement system 100, 200 (FIGS. 3, 5). Alignment can include moving the fan blade 48, 206 to the six o'clock (6:00) position. That is, projecting a clockface onto the fan casing assembly 40, 202, the fan blade 48, 206 positions at the bottom of the casing wall 42, 208, which relates to the 6:00 position. Additionally, alignment can include aligning the fan blade 48, 206 with a marking 106 (FIG. 3) on the clearance measurement system 100, such as a marking matching or complementary to the fan blade 48. Such an alignment can be done by hand, while it is contemplated that the clearance measurement system 100, 200 can include an alignment feature for positioning the fan blade 48 relative to the clearance measurement system 100, 200, such as a stop.

At 308, the method 300 can include measuring the fan blade tip clearance. Measuring the fan blade tip clearance can include measuring the gap 52, 204 (FIGS. 3. 5) for one or more, or all of the fan blades 48, 206 within the fan assembly 12 (FIG. 1) using the clearance measurement system 100, 200. Each fan blade 48, 206 of the fan casing assembly 40, 202 can be moved to the 6:00 position, successively, permitting the clearance measurement system 100 to remain within the gap 52, 204 at the same position on the casing wall 42. In this way, measurement of the fan blade tip clearance for all fan blades 48, 206 is achieved by rotating the fan assembly 12 and measuring each fan blade 48 at the 6:00 position. Such measurements can be made by stopping each fan blade 48 at the 6:00 position, or continuously rotating the set of fan blades 206. Additionally, the particular positioning of the sensors 110 can be used to measure multiple fan blade tip clearances for each fan blade 48, where it may be desirable to measure multiple fan blade tip clearance positions, where different fan blade tip clearances are utilized for a blade, or where a blade may have different clearance tolerances at different positions. In one example, the fan blade tip clearance can be measured at both a pressure side and a suction side of the blades to ensure fan blade tip clearances are within thresholds at both the pressure and suction sides. Furthermore, it is contemplated that the clearance measurement system 100 can consider its own height in making a measurement, as its positioning within the gap 52, 204 otherwise occupies a portion of the fan blade tip clearance. Additionally, the clearance measurement system 200 can measure the entirety of the blade tip using the first and second arrays of fibers 230, 232.

At 310, the method 300 can further include comparing the measured fan blade tip clearances at 308 against a threshold value or other value. For example, an individual fan blade 48, 206 can be compared against a first threshold or value, to determine if each fan blade 48, 206 is within individual fan blade tip clearance requirements. Additionally, it is contemplated that more than one fan blade 48, 206 can be considered as a set, or subset thereof. While each individual fan blade 48, 206 may be within the first threshold, determining a value among the entirety or subset of fan blades 48, 206 for the fan assembly 12 against a second threshold can further improve accuracy and consistency of measurement of the fan assembly 12. For example, if multiple fan blades 48, 206 on a first subset of the fan assembly 12 have a greater first clearance than multiple blades on a different subset of the fan assembly 12, an imbalance can exist or develop through cycle fatigue. The clearance measurement system 100, 200 can determine if these additional thresholds are exceeded, among a subset of blades, and can be used to correct an imbalance among fan blade tip clearances for the full set of the fan blades even where individual fan blades 48, 206 remain within thresholds.

At 312, the method 300 can include displaying the measured fan blade tip clearances. An output or display, such as the display 120 of FIG. 3, can output information related to the measured fan blade tip clearances. For example, a listing of the fan blade tip clearance for each fan blade 48, 206 can be provided, or an average fan blade tip clearance for the fan assembly 12, or listing instances of fan blades which are outside of required thresholds. It is further contemplated that the clearance measurement system 100, 200 can store historical information related to the fan blade tip clearances on a CPU 112 or memory 116, such that trends can be identified over time. Such trends can be displayed as well, such as if a particular trend exceeds a threshold, or is anticipated to exceed a threshold at a future time.

Benefits associated with the aspects described herein include greater speed, accuracy, and consistency in which fan blade tip clearances can be measured for the fan assembly 12. For example, during inspection after a flight, the clearance measurement system 100, 200 can be easily placed on a casing wall 42, 208, and rotating the fan blades 48, 206 to determine if the fan blades 48, 206 are still within fan blade tip clearances after flight or engine operation. Utilizing the clearance measurement system 100, 200 reduces or eliminates the opportunity for common measurement errors, such as those errors resultant from differences from technician- to-technician variation, such as parallax error, measurement position, gauge wear, blade-to-blade measurement variations, or the technician standing or sitting on the fan casing, in non-limiting examples. Such accurate and consistent measurement provides for a reduction in maintenance and inspection costs and time. Furthermore, improved accuracy and consistency among fan blade tip clearances reduces tip-clearance related blade rub or liberation, as well as a reduction in related operational disruptions resultant thereof. The improved accuracy and consistency reduces inefficiencies at the fan assembly 12 resultant of fan blade tip clearances that are too large, and reduces the opportunity for fan stall.

To the extent not already described, the different features and structures of the various embodiments can be used in combination, or in substitution with each other as desired. That one feature is not illustrated in all of the embodiments is not meant to be construed that it cannot be so illustrated, but is done for brevity of description. Thus, the various features of the different embodiments can be mixed and matched as desired to form new embodiments, whether or not the new embodiments are expressly described. All combinations or permutations of features described herein are covered by this disclosure.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A clearance measurement system for measuring a fan blade tip clearance in a turbine engine for a blade tip for a set of fan blades spaced from a fan casing assembly to define a gap, the clearance measurement system comprising: a pad removably located within the gap and having a sensor outputting a signal indicative of the distance between the pad and the blade tip.

The clearance measurement system of any preceding clause wherein the pad removably rests on the fan casing assembly.

The clearance measurement system of any preceding clause further comprising a marking on the pad.

The clearance measurement system of any preceding clause wherein the marking includes an airfoil shape complementary to each fan blade of the set of fan blades.

The clearance measurement system of any preceding clause wherein the sensor includes at least two sensors.

The clearance measurement system of any preceding clause wherein the at least two sensors are aligned on the pad to correspond to different chord-wise positions of each fan blade of the set of fan blades.

The clearance measurement system of any preceding clause wherein the pad flexes to conform to a shape of the fan casing assembly.

The clearance measurement system of any preceding clause further comprising a CPU communicatively coupled to the sensor to receive the signal.

The clearance measurement system of any preceding clause further comprising a display coupled to the sensor for displaying the signal.

The clearance measurement system of any preceding clause wherein the sensor is arranged as an array of fibers.

The clearance measurement system of any preceding clause wherein the array of fibers is arranged as a first array of fibers interlaced with a second array of fibers.

The clearance measurement system of any preceding clause wherein the pad includes a top and a bottom, and the first array of fibers extends from the top and the second array of fibers extends from the bottom.

The clearance measurement system of any preceding clause wherein the pad forms a housing defining an interior, and the array of fibers extends into the interior.

The clearance measurement system of any preceding clause wherein the array of fibers generates the signal resultant of an electrical resistance across the array of fibers.

The clearance measurement system of any preceding clause wherein the first array of fibers and the second array of fibers generates the signal resultant of an electrical resistance across the first array of fibers and the second array of fibers.

The clearance measurement system of any preceding clause wherein the array of fibers is a strain sensor.

The clearance measurement system of any preceding clause wherein the strain sensor enables detection of force.

The clearance measurement system of any preceding clause wherein the detection of force is calibrated to be represented as a distance for the gap.

The clearance measurement system of any preceding clause wherein the detection of force includes a pressure force, a shear force, or a torsional force.

The clearance measurement system of any preceding clause wherein the detection of force includes a directionality of the force.

The clearance measurement system of any preceding clause wherein the directionality of the force includes a torsional directionality, a linear directionality, or a curved directionality.

The clearance measurement system of any preceding clause wherein the directionality extends in two or more dimensions.

The clearance measurement system of any preceding clause wherein the housing is formed as polydimethylsiloxane.

The clearance measurement system of any preceding clause wherein the fibers are formed as nano-hairs.

The clearance measurement system of any preceding clause wherein the output signal includes an audible indication if the gap is not within a threshold.

The clearance measurement system of any preceding clause wherein the sensor includes at least one of a proximity sensor, a capacitance sensor, a resistance sensor, a distance sensor, a laser sensor, an ultrasonic sensor, an infrared sensor, an LED sensor, a LIDAR sensor, or VCSEL sensor.

A clearance measurement system for measuring a fan blade tip clearance for a set of fan blades, the clearance measurement system comprising: a pad; and a sensor coupled to the pad for generating a signal indicative of the fan blade tip clearance for the set of fan blades.

The clearance measurement system of any preceding clause wherein the pad includes a marking for aligning the set of fan blades relative to the pad.

The clearance measurement system of any preceding clause further comprising a CPU coupled to the sensor for receiving the signal.

The clearance measurement system of any preceding clause further comprising display for displaying the signal.

The clearance measurement system of any preceding clause wherein the display is connectable to the pad.

A method of measuring fan blade tip clearance between a set of fan blades and a fan casing assembly for a turbine engine, the method comprising: positioning a pad having a sensor within a gap between the set of fan blades and the fan casing assembly; and measuring the fan blade tip clearance for at least one fan blade of the set of fan blades with the sensor.

The method of any preceding clause further comprising comparing the measured fan blade tip clearance for the at least one fan blade to a first threshold.

The method of any preceding clause further comprising comparing the measured fan blade tip clearance for a subset of fan blades of the set of fan blades to a second threshold.

The method of any preceding clause wherein the first threshold and the second threshold are different.

The method of any preceding clause further comprising aligning a first blade of the set of blades with the clearance measurement system, wherein aligning the first blade with the clearance measurement system further includes aligning the first blade with a marking on the pad.

The method of any preceding clause further comprising displaying the measured fan blade tip clearance for the at least one fan blade on a display.

The method of any preceding clause further comprising calibrating the sensor to measure the fan blade tip clearance for the set of fan blades.

What is claimed is:

1. A clearance measurement system for measuring a fan blade tip clearance in a turbine engine for a blade tip for a set of fan blades spaced from a fan casing assembly to define a gap, the clearance measurement system comprising:
a pad removably located within the gap and having a sensor outputting a signal indicative of the distance between the pad and the blade tip.

2. The clearance measurement system of claim 1 wherein the pad removably rests on the fan casing assembly.

3. The clearance measurement system of claim 1 further comprising a marking on the pad.

4. The clearance measurement system of claim 3 wherein the marking includes an airfoil shape complementary to each fan blade of the set of fan blades.

5. The clearance measurement system of claim 4 wherein the sensor includes at least two sensors.

6. The clearance measurement system of claim 5 wherein the at least two sensors are aligned on the pad via the marking to correspond to a pressure side and a suction side of the set of fan blades.

7. The clearance measurement system of claim 6 wherein the at least two sensors further comprise at least four sensors, with at least two sensors of the at least four sensors arranged at a first chord-wise position and at least two sensors of the at least four sensors arranged at a second chord-wise position.

8. The clearance measurement system of claim 1 further comprising a CPU communicatively coupled to the sensor to receive the signal.

9. The clearance measurement system of claim 1 further comprising a display coupled to the sensor for displaying the signal.

10. A clearance measurement system for measuring a fan blade tip clearance for a set of fan blades spaced from an exterior casing, the clearance measurement system comprising:
a pad; and
a sensor arranged in the pad for generating a signal indicative of the fan blade tip clearance for the set of fan blades.

11. The clearance measurement system of claim 10 further comprising a marking provided on the pad.

12. The clearance measurement system of claim 10 further comprising a CPU coupled to the sensor for receiving the signal.

13. The clearance measurement system of claim 10 further comprising display for displaying the signal.

14. A method of measuring fan blade tip clearance between a set of fan blades and a fan casing assembly for a turbine engine, the method comprising:
positioning a pad having a sensor within a gap between the set of fan blades and the fan casing assembly; and
measuring the fan blade tip clearance for at least one fan blade of the set of fan blades with the sensor.

15. The method of claim 14 further comprising comparing the measured fan blade tip clearance for the at least one fan blade to a first threshold.

16. The method of claim 15 further comprising comparing the measured fan blade tip clearance for a subset of fan blades of the set of fan blades to a second threshold.

17. The method of claim 16 wherein the first threshold and the second threshold are different.

18. The method of claim 14 further comprising aligning a first blade of the set of blades with the pad and aligning the first blade with a marking on the pad.

19. The method of claim 14 further comprising displaying the measured fan blade tip clearance for the at least one fan blade on a display.

20. The method of claim 14 further comprising calibrating the sensor to measure the fan blade tip clearance for the set of fan blades.
